(19) United States
(12) Patent Application Publication
(10) Pub. No.: US 2009/0191401 A1
(43) Pub. Date: Jul. 30, 2009

(54) Magnetic paint

(76) Inventor: Dayton Joseph Deetz, Mendon, MA (US)

Correspondence Address: Dayton J. Deetz, Unit A, 1 Emerson Street, Mendon, MA, 01756, US

(21) Appl. No.: 11/116,820

(22) Filed: Apr. 28, 2005

(51) Int. Cl. B32B 27/18; B32B 27/32; B32B 27/36; H01F 1/00

(52) U.S. Cl. 428/323; 428/537.5; 428/500; 428/523; 428/480; 252/62.54; 252/62.53; 252/62.56; 252/62.55; 252/62.51 R; 106/31.64

(57) ABSTRACT

Magnetic receptive Paints and coatings have been developed to allow one to paint a wall with this coating and apply magnets to this surface. The further development of magnetic receptive coatings incorporates the use of multiple size particles giving the finished surface a smoother appearance and increasing the particle load in the dry mill surface. This is useful in the coating of substrates where the need to coat the thinnest possible coating on the surface of a substrate such as papers and films as well as painting on walls, gives you the highest magnetic receptive surface possible at the thinnest mill thickness of applied coating.

### TECHNICAL FIELD OF THE INVENTION

This invention relates to a coating incorporating a range of particle sizes that lends itself to leveling out to a smoother finished surface. We have developed a new standard of critical size requirement that plays out as follows. Using a preferred size of particle for your given requirement. It is important to maintain a range of what we call the 20-80 7×ps (seven times particle size multiplier). In short this is a separation of media that keeps all particles employed having a distribution of 20% through 80% of the particles that fall in a specified size range, for example, using particle sizes from 4 to 28 microns having 4 microns and smaller at the 20% and 28 microns and smaller at 80% gives you a size range capable of creating an almost solidly filled surface. All spaces between each of the larger particle sizes are filled in with each smaller sized particle until you have utilized your range of particles. This makes for a coating with a higher particulate load in a dry film thickness of a thinner standing than using standard screened particles with narrow ranges. This narrow range particle size is being incorporated in the magnetic paints now on the market. This is a very important discovery as the requirement to load the coating with a very high solids count is an absolute necessity to create a coating capable of holding magnets and performing with the needed flow characteristics. This will allow you to achieve a highly magnetic receptive surface with the thinnest coating allowed. The use of Magnetite (Fe₃O₄) is advantageous for a few reasons. First, this can be incorporated in an exterior coating exposed to the elements without any sign of oxidation causing rust stains. Second, is it is very friendly in aqueous coatings as an oxide and does not react with adverse effects in coatings. Using magnetite allows you to use the standard amounts of flash rust inhibitors in paint production as apposed to increasing the amount to ward off oxidation in the can.

### BACKGROUND OF THE INVENTION

Ferro magnetic particles have been incorporated in compositions, typically for use as metal repair formulations, metallic paint finishes, colorants, coating additives and manufacture of magnetic substrates. We have discovered that the parameters for a highly magnetic receptive coating require a careful selection of base resins. This is a resin with little to no fillers, lower solids and a low viscosity. This will allow one to use the magnetic receptive particles for all fillers required in the manufacturing process. This will make certain that most of the solids count will be magnetic receptive. Using the 20%-80% 7×ps as described above, will ensure a highly filled magnetic receptive layer of particles. The ultra smooth finish allows the magnet to have purchase on a very high percentage of the surface. With coatings containing particles with sizes in excess of 350 mesh the finished surface is sand like and reduces the surface contact of the magnet considerably. There is a very fine line between good performance and poor performance as the quantity of particles contained in the finished dry coating have an exponential effect 6 mil dry coat weight has more than double the 3 mil dry coat weight. This makes it critical to load your coating at a quantity of between 11-18 lbs per gallon of preferred particles.

In U.S. Pat. No. 5,587,102 Sterns discloses a specific latex paint with iron particles no smaller than 350 mesh. He has also employed a thickening agent of synthetic clay to keep his particles in suspension. Stern also discloses his technique for an oxidizing retarder. (Sodium benzoate). Sodium benzoate, ammonium benzoate, sodium nitrite. These are all flash rust inhibitors that have been used in the paint industry for years. Using a simple weight ratio of a rust inhibitor to iron added to your formula can be catastrophic as there are many types of particles available to utilize in magnetic coatings. For example if you use the ratio of 1.5% sodium benzoate per weight of iron employed, this could work with a solid particle but the part of the particle that oxidizes is the surface in contact with the elements. A sponge iron particle has sometimes twice the surface area as a comparable solid particle of the same size leaving the sponge iron weighing half as much this would create a problem of oxidation where the ph would drop and oxidation would commence. It is very important to calculate the surface area to weight ratio of the particles you wish to employ. The addition of ph stabilizers is also recommended, for absolute insurance to prevent oxidation.

In U.S. Pat. No. 5,843,329 I disclose the techniques for the simple blending of magnetic receptive particles of certain sizes into a pre mixed solution capable of rendering any coating magnetic. This is a very good way of producing an easy to blend magnetic coating but has its limitations in up scale manufacturing and consumer paint products. I further disclose the method of producing coatings and subsequent substrates coated with coating containing Ferro magnetic particles. I do not use the formula of 20-80 7×ps in this invention.

### DETAILED DESCRIPTION OF THE INVENTION

It is an object of the invention to provide a magnetic coating that displays the properties of a highly magnetic receptive paint, ink or coating having a solids embodiments of between 60% and 85%. Using the particle choice of 20% 80% 7×ps factor to ensure the highest level of residual particle load. This will produce a coating that will give the highest available magnetic receptive qualities with the least amount of mill thickness. This is ideal for consumer based paint products and coating applications for magnetic receptive substrates.

This invention further encompasses substrates coated with magnetic products of the invention such as magnetic signboards and toys. Typical surfaces include vinyl, wood, foam, plywood, plastic, fiberboard, paper, wallpaper, cloth, and PVC. Polypropylene films, poly ester films and the like coated with magnetic products of the invention are advantageous because they can be cut on site with conventional wood-working tools, scissors or knives to provide, game-boards, wallpaper, games dolls, lithograph paper, films, chalkboards and the like.

Other improvements in the coating derived are the specific blend of latexes and or acrylics with different harnesses. This will achieve a dry film soft enough to bend but not crack and will render the surface hard enough to except chalk and not scratch the surface. This enables one to produce paper chalkboards. The employment of Magnetite is quite useful for this product as you can add color and create a true black magnetic receptive coating that is a very erasable chalkboard. The properties Magnetite share with talcum powder is advantageous for a chalkboard coating. This helps with the erase ability. Further more you can employ the same technology blending these particles with adhesive coatings to create a magnetic receptive adhesive for a one step laminating process.

### EXAMPLES

The following examples are presented to further illustrate and explain the present invention and should not be taken as limiting in any regard.
To produce a magnetic receptive coating we blend the following to produce a round 5 gallons.

### Example 1

### 19.46 lbs of Latex

### 10.4 oz of Propylene Glycol

### 3 lbs of Floetrol

5 lbs of TI 02 dispersion
22 oz water
80 lbs magnetite
6 oz sodium benzoate
6 oz polyphobe TR 117
Blend latex, Propylene glycol, floetrol, sodium benzoate, TI02 and water together for 5 minutes. Slowly add magnetite. After all magnetite is dispensed mix for additional 10 minutes add polyphobe TR117 and blend for 5 minutes

### Example 2

This coating works well on substrates
Blend 23 lbs of hycar 26120 with 80 lbs of magnetite for 20 minutes.

### Example 3

Coat a substrate with a coating thick enough to hold magnets. This can be done using any conventional coating system.

### Example 4

18 lbs of hard Acrylic Latex

### 8.4 oz of Propylene Glycol

### 2 lbs of Floetrol

5 lbs of Black universal tint
10 oz water
78 lbs magnetite
4 oz sodium benzoate
7 oz polyphobe TR 117
Blend latex, Propylene glycol, floetrol, sodium benzoate, black tint and water together for 5 minutes. Slowly add magnetite. After all magnetite is dispensed mix for additional 10 minuets add polyphobe TR117 and blend for 5 minutes

1. A coating composition comprising ferromagnetic particles selected using a standard of the 20% through 80% seven times multiple for particle size

2. A paint, ink or coating composition according to claim 1 formulated to contain from about 11 to about 18 lbs of particles per yielded gallon of said coating.

3. A screen ink or coating composition according to claim 1.

4. A paint, ink or coating composition according to claim 1 comprising a latex medium.

5. A paint ink or coating composition according to claim 1 comprising an acrylic medium.

6. A substrate coated with a coating composition employing ferromagnetic particles selected using a standard of the 20% through 80% seven times multiple for particle size having a dry mill finish of about 1 to 20 mils, and containing from about 0.01 to about 0.20 pounds of ferromagnetic particles per square foot.

7. A substrate according to claim 6 selected from the group consisting of paper, vinyl, chip board, wallpaper, polystyrene, polyester poly propylene, poly ethylene, cloth and PVC.

8. A substrate according to claim 6 wherein the coating is latex.

9. A substrate according to claim 6 wherein the coating is solvent based.

10. A paint, ink, or coating where the presents of anti oxidizers are calculated by surface area of magnetic particles, not magnetic receptive particle weight.

11. A substrate made up of more than one layer with the presence of coatings of claim 1 sandwiched between the products layers.

12. Game boards of the same in claim 11

13. Cloth fibers being coated or impregnated with coatings comprised from claim 6

14. A magnetic substrate that can be cut with conventional woodworking tools, scissors, knives, computer plotters and the like, comprising a substrate coated with a coating with ferromagnetic particles selected using a standard of the 20% through 80% seven times multiple for particle size.

15. A magnetic substrate according to claim 26 where the substrates are laminated coated side to coated side to create a sandwiched product.

16. A substrate coated with the coating according to claim 1 and 26 where the substrate is laminated with a polyester film over the coated surface.

17. A substrate according to claims 1 and 26 with the balance of resin in which the magnetic surface will except chalk and erase with minimal to no scratching.

18. A substrate according to claims 27 and 28 where the substrates have a remountable adhesive on the backside.

19. A wallpaper liner paper with the coating according to claims 1 and

20. A chalkboard wallpaper according to claims 1, 6 and 14 with a pre-pasted back.

21. A chalkboard wallpaper according to claims 1, 6 and 14 without a pre-pasted back

22. A line of wallpapers and printed murals according to claims 1, 6 and 14 that are pre printed with and without adhesive backs.

23. A blend of coating according to claim 1 simply mixed with a 100% solids monomer adhesive. To process in a one step electron beam laminating process to yield a substrate with an iron weight of between 0.01 lbs and 0.20 lbs per square foot.

24. A substrate coated with an adhesive according to claim 1 to allow a one step laminating process for papers board and films.

25. A magnetic receptive chalkboard paint containing magnetite in sufficient quantities to adhere magnets.
